(19) United States
(12) Patent Application Publication
(10) Pub. No.: US 2023/0390769 A1
(43) Pub. Date: Dec. 7, 2023

(54) HYDRODYNAMIC SEPARATOR WITH TAPERED MICROFLUIDIC CHANNEL

(71) Applicant: Donaldson Company, Inc., Bloomington, MN (US)

(72) Inventors: Jacob A. Nelson, Bloomington, MN (US); Davis B. Moravec, Burnsville, MN (US); Daryl L. Quam, Bloomington, MN (US)

(21) Appl. No.: 18/204,105

(22) Filed: May 31, 2023

Related U.S. Application Data
(60) Provisional application No. 63/347,915, filed on Jun. 1, 2022.

(51) Int. Cl. B01L 3/00

(52) U.S. Cl. CPC B01L 3/502761

(57) ABSTRACT

The technology disclosed herein relates to hydrodynamic separator. The hydrodynamic separator can be configured to separate a liquid having dispersed particles having a diameter. The hydrodynamic separator has a substrate and a liquid channel at least partially defined by the substrate. The liquid channel is configured to receive a liquid within the channel. The liquid channel has an inlet and an outlet. The outlet has a first outlet branch and a second outlet branch. The liquid channel has an inner wall defining an inner radius around a central axis and an outer wall defining an outer radius around the central axis. The liquid channel has a liquid channel length along the inner wall from the inlet to the outlet. The liquid channel has a channel width between the inner wall and outer wall, where the channel has a tapered region where the channel width increases towards the outlet.

### RELATED APPLICATION

The present application claims priority to U.S. Provisional Application No. 63/347,915 filed on 1 Jun. 2022, which is incorporated by reference herein in its entirety.

### TECHNOLOGICAL FIELD

The present disclosure is generally related to hydrodynamic separators. More particularly, the present disclosure is related to hydrodynamic separators with a tapered microfluidic channel.

### BACKGROUND

Hydrodynamic separators are used in a variety of industries for concentration and/or separation of particles in fluid streams such as hydrocarbon liquids, beverages, aqueous solutions, and the like. Particles suspended in the fluid may cause problems in system processes (such as, for example, in fuel or hydraulic systems), may generally be undesirable to consumers (for example, pulp in orange juice or impurities in beer or wine), or may be subject to different processing steps than the fluid (such as in sewage treatment). It can be desirable to design such hydrodynamic separators to achieve proper particle separation with minimal pressure drop to improve particle separation and efficiency in terms of both energy expenditure and time.

### SUMMARY

Some embodiments of the technology disclosed herein relate to a hydrodynamic separator configured to separate a liquid having dispersed particles having a diameter (a). The hydrodynamic separator has a substrate. The hydrodynamic separator has a liquid channel defined by the substrate. The liquid channel is configured to receive a liquid within the channel. The liquid channel has an inlet and an outlet. The liquid channel has an inner wall defining an inner radius around a central axis and an outer wall defining an outer radius around the central axis. The liquid channel has a liquid channel length along the inner wall from the inlet to the outlet. The liquid channel has a rectangular cross-section along the liquid channel length. The rectangular cross-section has a channel width between the inner wall and outer wall, where the channel has a tapered region where the channel width increases at a constant rate between 0.00 and 0.01 mm per mm liquid channel length towards the outlet.

In some such embodiments, the tapered region extends from the inlet to the outlet. Additionally or alternatively, the inner radius is constant from the inlet to the outlet. Additionally or alternatively, the outer radius tapers outward between the inlet and the outlet. Additionally or alternatively, the liquid channel has a first region having a first channel width and a first liquid channel length, a second region having a second channel width and a second liquid channel length, and the tapered region having a tapered region length that extends from the first region to the second region. Additionally or alternatively, the first region has a larger length than the second region. Additionally or alternatively, the separator is configured to have a Dean number (De) between 5 and 25 in the first region and the second region. Additionally or alternatively, the particle diameter (a) is greater than 8% of a hydraulic diameter (D_{H}) in at least the first region. Additionally or alternatively, the separator is configured to separate particles up to three times as dense as the liquid. Additionally or alternatively, the outlet has a first outlet and a second outlet. Additionally or alternatively, the liquid channel is one of a plurality of identical liquid channels.

Some embodiments of the technology disclosed herein relate to hydrodynamic separator. The hydrodynamic separator can be configured to separate a liquid having dispersed particles having a diameter (a). The hydrodynamic separator has a substrate and a liquid channel at least partially defined by the substrate. The liquid channel is configured to receive a liquid within the channel. The liquid channel has an inlet and an outlet. The outlet has a first outlet branch and a second outlet branch. The liquid channel has an inner wall defining an inner radius around a central axis and an outer wall defining an outer radius around the central axis. The liquid channel has a liquid channel length along the inner wall from the inlet to the outlet. The liquid channel has a channel width between the inner wall and outer wall, where the channel has a tapered region where the channel width increases towards the outlet.

In some such embodiments the tapered region extends from the inlet to the outlet. Additionally or alternatively, the inner radius is constant from the inlet to the outlet. Additionally or alternatively, the outer radius tapers outward between the inlet and the outlet. Additionally or alternatively, the liquid channel has a first region having a first channel width and a first liquid channel length, a second region having a second channel width and a second liquid channel length, and the tapered region having a tapered region length that extends from the first region to the second region. Additionally or alternatively, the first region has a larger length than the second region. Additionally or alternatively, the separator is configured to have a Dean number (De) between 5 and 25 in the first region and the second region. Additionally or alternatively, the particle diameter (a) is greater than 8% of a hydraulic diameter (D_{H}) in at least the first region.

Additionally or alternatively, the separator is configured to separate particles up to three times as dense as the liquid. Additionally or alternatively, the inner radius is greater than or equal to 10 mm and less than or equal to 100 mm. Additionally or alternatively, the liquid channel is one of a plurality of identical liquid channels defined by the substrate. Additionally or alternatively, the liquid channel has a width ranging from 400 μm to 1000 μm. Additionally or alternatively, the liquid channel has a height ranging from 100 μm to 500 μm. Additionally or alternatively, the liquid channel has a polygonal cross-section along the liquid channel length. Additionally or alternatively, the liquid channel has a rectangular cross-section along the liquid channel length.

Additionally or alternatively, the channel width of the liquid channel does not change more than 10 mm per mm liquid channel length along the liquid channel. Additionally or alternatively, the channel width increases at a constant rate in the tapered region. Additionally or alternatively, the liquid channel has a first region having a first channel width and a tapered region having an increasing channel width from the first region to the outlet. Additionally or alternatively, the liquid channel has a plurality of tapered regions, each having an increasing channel width towards the outlet. Additionally or alternatively, the liquid channel is a microfluidic channel.

The above summary is not intended to describe each embodiment or every implementation. Rather, a more complete understanding of illustrative embodiments will become apparent and appreciated by reference to the following Detailed Description of Exemplary Aspects and claims in view of the accompanying figures of the drawing.

### BRIEF DESCRIPTION OF THE DRAWINGS

FIG. 1 is a schematic representation of an example hydrodynamic separator system consistent with embodiments.

FIG. 2 is a cross-sectional view of the liquid channel of FIG. 1.

FIG. 3 is a plot representing particle focusing along the length of a liquid channel.

FIG. 4 is a plot of typical radial flow profiles for different Dean numbers consistent with a liquid channel.

FIG. 5 is a plot of experimental results against a prior art equation defining radial flow velocity.

FIG. 6 is a plot of experimental results against a new equation defining radial flow velocity.

FIG. 7 is a plot of experimental results against a first equation defining particle focusing length.

FIG. 8 is a plot of experimental results against a second equation defining particle focusing length, where the second equation takes particle size into account.

FIG. 9 is a plot of experimental results against a third equation defining the arc measure of the liquid channel.

FIG. 10 is a schematic diagram representing an example hydrodynamic separator with a helical liquid channel.

FIG. 11 is a facing view of the example hydrodynamic separator of FIG. 10.

FIG. 12 is another example system consistent with embodiments.

FIG. 13 is yet another example system consistent with embodiments.

The present technology may be more completely understood and appreciated in consideration of the following detailed description of various embodiments in connection with the accompanying drawings.

The figures are rendered primarily for clarity and, as a result, are not necessarily drawn to scale. Moreover, various structure/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION

Hydrodynamic separators consistent with the present disclosure are microfluidic devices capable of focusing particles within a fluid stream relying only on the forces due to internal fluid flow. The particles can be separated from a portion of the fluid steam and/or separated from particles of other sizes within the fluid stream. The hydrodynamic separator generally defines a fluid channel having an inlet and an outlet having at least two flow branches. Particles within a particular size range may be focused, or concentrated, into one of the two flow branches. For example, particles exceeding a threshold size range are focused into one of the two flow branches. The concentrated portion of the fluid flow may be removed from the system or retained for further processing. Any remaining particles may flow through the at least two flow branches.

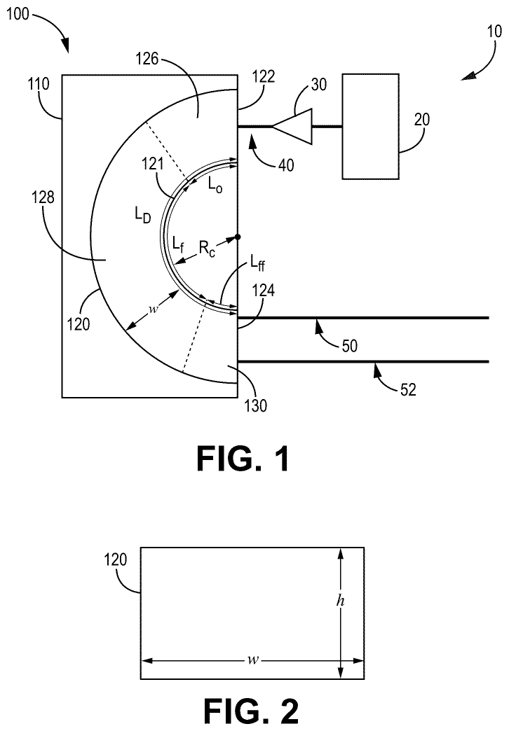

FIG. 1 is a schematic representation of an example system 10 consistent with some implementations of the technology disclosed herein. The system 10 is a hydrodynamic separator system that is configured to focus particles that are suspended in a fluid stream. The system 10 has a hydrodynamic separator 100 having a liquid channel 120 having an inlet 122 and an outlet 124. A fluid pump 30 creates fluid communication between a fluid source 20 and the hydrodynamic separator 100. In particular, the fluid pump 30 is configured to pump fluid from the fluid source 20 through an inlet flow channel 40 to the inlet 122 of the hydrodynamic separator 100. The fluid is configured to flow through a liquid channel 120 of the hydrodynamic separator 100 to the outlet 124. The outlet 124 has a first outlet branch 50 and a second outlet branch 52 that can lead from the liquid channel 120 to other systems or other system components. In some embodiments, fluid flowing through the first outlet branch 50 is configured to have a higher concentration of particles within a particular size range compared to fluid flowing through the second outlet branch 52.

The hydrodynamic separator consistent with the technology disclosed herein are generally constructed of a substrate 110. The substrate 110 at least partially defines the liquid channel 120 therein. The substrate 110 can be constructed of a variety of different materials and combinations of materials. The substrate can be polymeric, in some embodiments. In some examples the substrate includes acrylic. In some examples the substrate includes polycarbonate. In some examples the substrate includes polydimethylsiloxane (PDMS). In some embodiments the substrate can include glass. In some embodiments the substrate can include a non-reactive metal. In some embodiments the substrate can include one or more adhesive layers, such as a pressure-sensitive adhesive. In some embodiments the substrate may be two or more materials, such that the walls of the channels may be two or more materials.

The liquid channel 120 is generally configured to accommodate liquid flow. The liquid channel 120 defines the inlet 122 and the outlet 124. The liquid channel 120 defines a channel length L_{D} from the inlet 122 to the outlet 124. The liquid channel 120 is generally curved to define an inner radius R_{C} about a central axis x. As such, the liquid channel 120 extends circumferentially about the central axis x to define a channel arc measure. In the current example, the liquid channel 120 extends about 180° about the central axis x. In the current example, the inner radius R_{C} is substantially constant along the length of the channel, but in some other examples, the inner radius R_{C} can vary. In some implementations, the inner radius R_{C} is greater than or equal to 5 mm, 10 mm, or 15 mm. In some implementations, the inner radius R_{C} is less than or equal to 100 mm, 60 mm, 50 mm, or 30 mm.

In various embodiments, the liquid channel 120 of the hydrodynamic separator is a microfluidic channel, where the term “microfluidic channel” refers to a channel having at least one dimension less than 1 millimeter (1000 micrometers). A microfluidic channel may have a channel width less than 1000 micrometers, a channel height (or depth) less than 1000 micrometers, or both. In some embodiments, for higher flow applications, at least one dimension of the microfluidic channel may be greater than 1 millimeter. In some embodiments, at least one dimension of the microfluidic channel is greater than or equal to 1, 2, 3, 4, 5, 6, 7, 8, 9, or 10 millimeters or less than or equal to 10, 9, 8, 7, 6, 5, 4, 3, or 2 millimeters. In general, the channel may have any suitable length to provide a suitable pressure drop balanced with suitable particle focusing.

Microfluidic channels may be described by a cross-sectional area. The cross-section of the liquid channel 120 as used herein is generally perpendicular to the direction of fluid flow through the channel 120. In some embodiments, the cross-sectional area of the microfluidic channel may be less than 10, 9, 8, 7, 6, 5, 4, 3, or 2 millimeters squared (mm²).

The liquid channel 120 can generally have any shaped cross-section along the channel length that is a closed loop around the liquid channel 120. In some embodiments, the liquid channel 120 has a curved cross-section such as a circular or ovular cross-section. In some embodiments the liquid channel 120 has a polygonal cross-section. In some embodiments, the liquid channel 120 has an irregular cross-section. In the example of FIG. 2, the liquid channel 120 has a rectangular cross-section along the channel length. The term “rectangular” as used herein encompasses a square shape. The channel 120 has a height (h) that is visible in FIG. 2, and a width (w) that is visible in both FIGS. 1 and 2. For liquid channels having a curved and/or irregularly-shaped cross-section, the width and the height are generally the maximum width and the maximum height across the cross-section.

Microfluidic channels may also be described by a hydraulic diameter. The channel 120 also has a hydraulic diameter (D_{H}). The following equation is used to calculate the hydraulic diameter of a microfluidic channel:

$${D}_{H} = \frac{4 \times cross - sectional area}{cross - sectional perimeter}$$

where the “cross-sectional perimeter” is the length of the perimeter around the cross-sectional area. The following equation is used to calculate the hydraulic diameter of a microfluidic channel that specifically has a rectangular cross-section:

$${D}_{H} = \frac{2 \times height \times width}{height + width}$$

In some embodiments, the hydraulic diameter of the microfluidic channel may be less than 5, 4, 3, 2, or 1 mm. In at least one embodiment, the hydraulic diameter of the microfluidic channel of the microfluidic channel may be less than 1 mm.

The liquid channel 120 can be formed in the substrate 110 through molding operations, laser cutting, micro-machining, photolithography, and 3D printing, as examples. In some examples, the liquid channel 120 is formed in the substrate 110 through injection molding or embossing of plastics. Other approaches can also be used to form the liquid channel 120. In various embodiments, the hydrodynamic separator 100 defines a plurality of identical liquid channels 120 that are configured to operate in parallel. In various embodiments, the hydrodynamic separator 100 has at least 10 liquid channels. In various embodiments, the hydrodynamic separator 100 has at least 50 liquid channels or at least 100 liquid channels.

In some embodiments where the hydrodynamic separator 100 has a plurality of identical liquid channels, one liquid channel 120 can be defined within a single substrate layer. In some other embodiments, a single substrate layer can define a plurality of liquid channels 120. The liquid channels within the substrate layer can be configured to operate in parallel. In various embodiments, multiple substrate layers can be layered in a stacked configuration such that the liquid channel(s) 120 defined by each substrate layer are also in a stacked configuration. The stacked layers of substrate and the liquid channels 120 form the hydrodynamic separator 100. The hydrodynamic separator 100 can define the inlet flow channel 40 upstream of and in direct fluid communication with each of the microfluidic channel inlets (such as the inlet 122). The inlet flow channel 40 will generally have a hydraulic diameter that is larger than the hydraulic diameter of each of the liquid channels 120. The hydrodynamic separator 100 can define the first outlet branch 50 and the second outlet branch 52 that are both positioned downstream of, and in direct fluid communication with, the outlet 124. Each of the first outlet branch 50 and the second outlet branch 52 will generally have a hydraulic diameter that is larger than the hydraulic diameter of each of the liquid channels. Such a configuration may advantageously equalize flow through the channels.

The liquid channel 120 is configured to receive a liquid having a Reynolds number (Re) within the liquid channel. The fluid flow within a curving channel is described by two non-dimensional numbers, the Reynolds number and the Dean number. The Reynolds number describes the ratio of inertial forces to viscous forces, and is defined as:

$$Re = \frac{ρ {UD}_{H}}{μ}$$

where ρ is the fluid density, U is the average fluid velocity, and μ is the dynamic viscosity of the fluid. In hydrodynamic separators the Reynolds number is typically small (<1000), which means that the flow profile is laminar. In various embodiments, the system is configured to have a Dean number (De) between 5 and 25. In various embodiments, the system is configured to have a Dean number between 5 and 20. The Dean number describes fluid behavior in a curved pipe and accounts for inertial forces, centripetal forces, and viscous forces acting on the fluid. The Dean number is defined as:

$$De = Re \sqrt{\frac{{D}_{H}}{2 {R}_{c}}} .$$

The hydrodynamic system 10 is generally configured to focus particles in the liquid channel 120. As used herein, the term “particle” refers to a discrete amount of material, which is dispersed in a fluid. Non-limiting examples of material that may be formed particles include dirt, metal, cells, air bubbles, fat, water droplets. In one particular example, water droplets may be dispersed in a hydrocarbon fluid, such as gasoline or diesel fuel, to form an emulsion. In another example, air bubbles may be dispersed in a hydraulic fluid. In another example, cells may be dispersed in an aqueous fluid. In yet other examples, particles may be pulp in orange juice, fat in milk, and impurities in beer or wine.

In various implementations, hydrodynamic separator 100 is configured to focus particles having a diameter of greater than 8% of the hydraulic diameter of the liquid channel 120. Particles whose diameter are greater than 8% of the channel hydraulic diameter are generally focused towards the inner wall when the Dean number ranges from 5 to 25. The hydrodynamic separator is generally configured to focus particles having a diameter that is less than or equal to 50% of the channel height. In various examples, for purposes of calculations provided herein, the particles have a sphericity of greater than 0.5. For non-spherical particles, for purposes of calculations provided herein, the particle diameter is considered to be the volume-equivalent spherical diameter. In various embodiments, hydrodynamic separators consistent with the technology disclosed herein are configured to focus particles having a density up to three times as dense as the liquid in the liquid channel 120.

Particle focusing occurs in two distinct stages. The first stage is a particle migration stage where the suspended particles migrate from across the liquid channel 120 to the top and bottom edges of the liquid channel 120. The particle migration stage generally starts at the liquid channel inlet 122 and extends a particle migration length Lₒ of the liquid channel 120 to define the particle migration region 126 of the liquid channel 120. In this region no additional focusing on the inner wall 121 of the liquid channel 120 is observed. The second region is a linear focusing region 128 in which the amount of focusing on the inner wall 121 increases linearly along the channel length. The focusing continues until a maximum particle focusing is reached. No additional focusing is observed after maximum particle focusing is reached. Linear focusing region 128 has a linear focusing length L_{f} that is the length necessary to achieve maximum particle focusing. The linear focusing region 128 generally extends from the particle migration region 126 towards the channel outlet 124.

The length of the liquid channel 120 after the linear focusing region 128 is referred to as the fully focused region 130. The fully focused region 130 has a length L_{ff} that extends from the linear focusing region 128 to the outlet 124. In various implementations it can be desirable to limit or eliminate the fully focused region 130 in order to decrease the energy requirements of the system by lowering the pressure drop across the liquid channel 120 while still achieving maximum particle focusing.

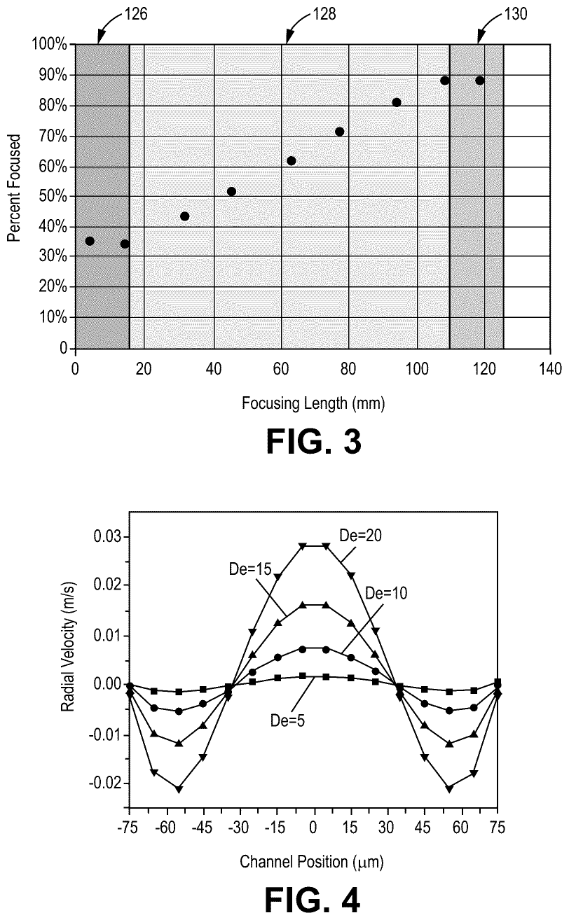

FIG. 3 is a graph depicting representative focusing behavior demonstrating the three stages of particle focusing along the length of a curved liquid channel. The particle migration region 126 accounts for approximately the first 16 mm of the length of the channel, and the linear focusing region 128 follows. In this example, the linear focusing region 128 achieves maximum particle focusing around 114 mm along the length of the liquid channel. Once the maximum value of particle focusing is reached, the particle focusing may stay approximately constant. This region of the device is considered the fully focused region 130, which was mentioned above. In this example, the maximum focusing percentage in the fully focused region shows is about 90% (that is, 90% of the particles are focused).

Mathematically, the length of the linear focusing region necessary to achieve maximum particle focusing in a curved channel (such as that depicted in FIG. 1) is a linear function based on the radial component of the particle velocity through the channel. According to existing literature (see, for example, Di Carlo, D., Irimia, D., Tompkins, R. G., Toner, M.; Continuous Inertial Focusing, Ordering, and Separation of Particles in Microchannels. Proceedings of the National Academy of Sciences of the U.S.A., November 2007, Vol. 104, No. 4, 18892-7.), the magnitude of the radial component of the Dean Flow profile, or the linear focusing rate U_{D}, is the following:

$${U}_{D} \sim \frac{{De}^{2} μ}{ρ {D}_{H}} .$$

This relationship was tested on rectangular channels using computational fluid dynamics in STAR-CCM+ software by Siemens PLM Software based in Plano, Texas. To measure the radial flow component, a function probe was inserted in the center of the virtual fluid domain, aligned with the depth of the channel (in the Z direction) at discrete radial positions along the primary fluid flow direction. An example series of typical radial flow profiles are shown in FIG. 4, where the radial velocity is a function of the depth through the center of the channel. The flow profiles shown are of a single device geometry and fluid combination across varying Dean numbers but with constant channel height h (150 μm), width w (500 μm), and inner radius R_{C} (20 mm). In this coordinate system positive flow velocities indicate fluid is moving towards the outer wall of the device, while negative flow velocities indicate fluid is moving towards the inner wall of the device. At the center of the channel depth the maximum radial flow component is observed. This corresponds to the maximum velocity towards the outer wall due to fluid inertia. There are two minimum radial flow components, symmetrically observed above and below the center of the channel depth. These flow components are the recirculating flow towards the inner wall, which are ultimately responsible for passively moving particles to the final focusing position.

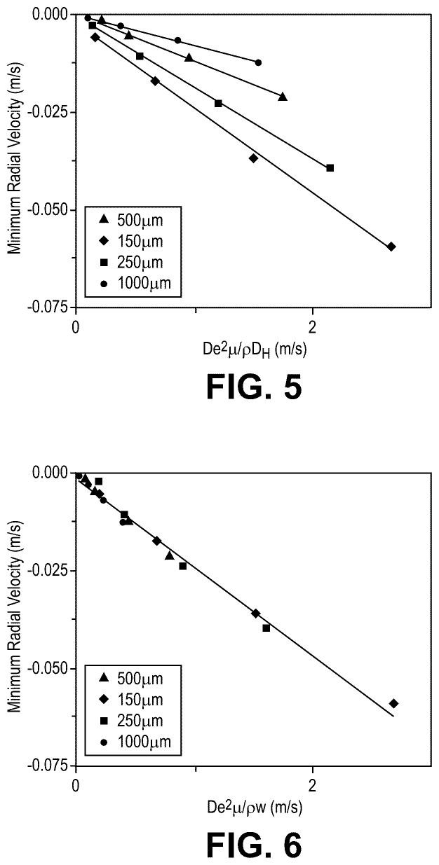

The minimum radial flow velocities for different liquid channel widths at four different Dean numbers (De=5, 10, 15, 20) were plotted against the literature equation for the magnitude of the radial component of the Dean Flow profile, which is reflected in FIG. 5. As is visible, the equation does not define a linear relationship across different liquid channel widths and thus is not an accurate predictor of radial velocity. Over the course of further testing and analysis, the following relationship was discovered for the linear focusing rate U_{D}:

$${U}_{D} \sim \frac{{De}^{2} μ}{ρ w} .$$

This equation was plotted against the minimum radial velocity and the results are reflected in FIG. 6. As is visible, the data from devices with different liquid channel widths collapse into a single linear curve. This relationship holds true when changing device geometry (width, height, and R_{C}) and fluid properties (viscosity and density) over the range of Dean numbers relevant to hydrodynamic separators (5<De<25). Specifically, the minimum radial velocity was found to be the following:

$${U}_{D} = - 0.02597 * \frac{{De}^{2} μ}{ρ w} - 1.107 * {10}^{- 4}$$

where μ is in cP, w is in microns, ρ is g/cm³ and U_{D} is in m/s.

Based on the minimum radial velocity, an equation to determine the length of the linear focusing region to obtain maximum particle focusing can be derived. The velocity across the width of the liquid channel is nearly constant, so the time it takes for a particle to transit the width of the liquid channel to the inner wall is:

$$t ∝ \frac{w}{{U}_{D}} = \frac{{w}^{2} ρ}{{De}^{2} μ} .$$

As such, the length of the linear focusing region is:

$${L}_{f} ∝ t U = \frac{{w}^{2} ρ}{{De}^{2} μ} U$$

where U is the average velocity of the fluid. Substituting in

$$U = \frac{Re μ}{ρ {D}_{H}}$$

yields:

$${L}_{f} ∝ \frac{Re}{{De}^{2}} \frac{{w}^{2}}{{D}_{H}} = \frac{2 {R}_{c}}{Re} {( \frac{w}{{D}_{H}} )}^{2}$$

and, more specifically,

$${L}_{f} = 156.2 \frac{{R}_{c}}{Re} {( \frac{w}{{D}_{H}} )}^{2} + 24.3 .$$

Linear focusing region is generally shorter at a higher Dean number, and because the operative range for a hydrodynamic separator consistent with the technology disclosed herein is a Dean number ranging from 5 to 25, the linear focusing length L_{f} will generally be a minimum of

$${L}_{f} = \frac{{Re w}^{2}}{8 {D}_{H}} + 24.3 .$$

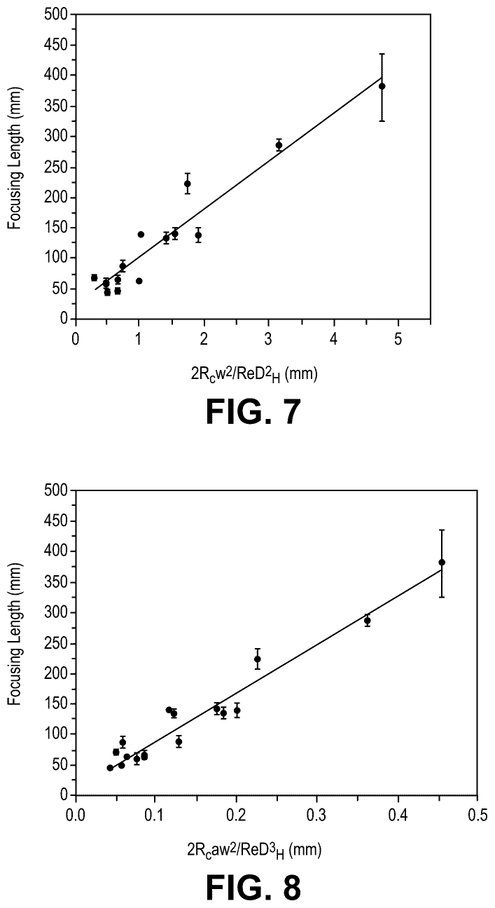

Using the particle focusing rate (i.e. the slope of the linear focusing region) the length required to focus an additional 80% of particles was calculated. An additional 80% of particles being focused would bring the focusing efficiency to greater than 90% because at the device inlet 10-20% of the particles are already in the focusing position. The observed focusing length associated with experimental results were plotted against the focusing length L_{f} equation above, which is reflected in FIG. 7. Error bars correspond to the standard error based on the uncertainty in the slope of the linear focusing region. This fit shows a clear trend, which is dominated by changes in device width and radius of curvature. A closer look at the data suggests that the focusing length L_{f} is dependent on particle size. Specifically, smaller particles focus faster than larger particles. Indeed, particles of different sizes will experience different lift forces, and thus transit the width of the device at different heights. It was discovered that taking the linear focusing length L_{f} and multiplying it by the particle confinement (a/Dₕ) yields

$${L}_{f} ∝ \frac{2 {R}_{c} a {w}^{2}}{{Re D}_{H}^{3}}$$

and, more specifically,

$${L}_{f} = 1598.8 \frac{{R}_{c} a {w}^{2}}{{Re D}_{H}^{3}} + 6.4$$

which is plotted against the observed experimental focusing lengths as reflected in FIG. 8. The data collapsed onto a linear fit, giving an R² value of greater than 0.95.

Instead of being described in terms of the length of the linear focusing region L_{f}, the linear focusing region can also be described in terms of the focusing angle (α), which is the arc measure (degrees) of the linear focusing region 128 about the central axis x:

$$α ∝ \frac{a {w}^{2}}{{π R e D}_{H}^{3}}$$

or, more specifically,

$$α = 265 , 682 \frac{a {w}^{2}}{{π R e D}_{H}^{3}} + 45.1$$

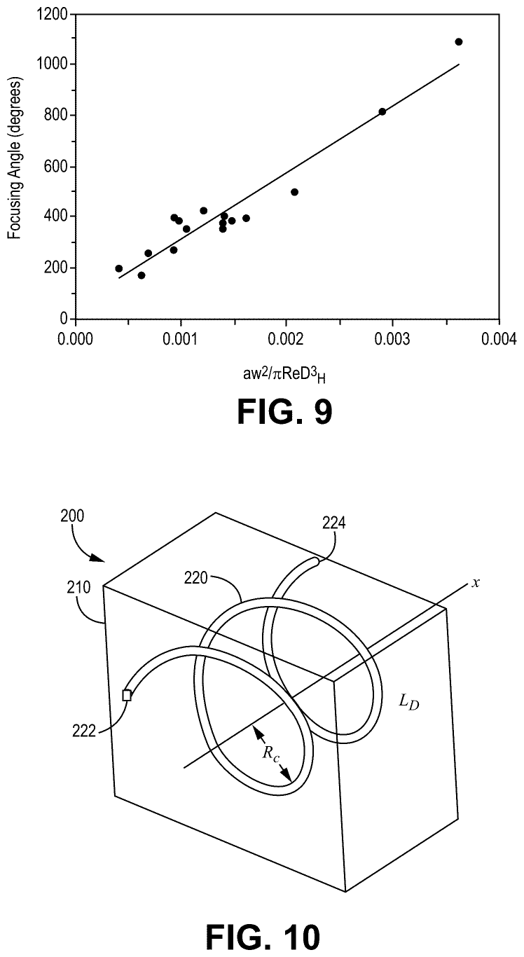

which is plotted against experimental data in FIG. 9. As demonstrated, various liquid channels consistent with the technology disclosed herein require a focusing angle of greater than 360 degrees, indicating that full focusing cannot occur with a “simple” hydrodynamic separator, where a “simple” hydrodynamic separator is one where the liquid channel is less than a full revolution about the central axis x.

A series of experiments were conducted that measured the actual particle migration length L₀ and the particle focusing length L_{f} of various hydrodynamic systems consistent with the technology disclosed herein. Hydrodynamic separators of varying device heights and widths were created out of PDMS and glass slides using standard methods. Solutions of fluorescently labeled particles were introduced to the hydrodynamic separator channel at known flowrates within the Dean numbers of 5-25. Images were taken at various locations along the hydrodynamic separator using a CMOS camera. Image processing was used to identify particle concentration as a function of channel position and length. The particle focusing length L_{f} was also calculated in accordance with equations provided above. The results are reflected in Table 1, below.

TABLE 1

| No. | Experimental L₀ (mm) | Experimental L_{f} (mm) | Experimental (Lo/(Lo + Lf)) | Lo/Lf | $\begin{matrix}{L}_{f} = \\ 156.2 \frac{{R}_{c}}{Re} {( \frac{w}{{D}_{H}} )}^{2} + 24.3\end{matrix}$ | $\begin{matrix}{L}_{f} = \\ 1598.8 \frac{{R}_{c} {aw}^{2}}{Re {D}_{H}^{3}} + 6.4\end{matrix}$ |
|---|---|---|---|---|---|---|
| 1 | 13 | 381 | 3.30% | 3.4% | 395 | 370 |
| 2 | 0 | 87 | 0% | 0% | 82 | 110 |
| 3 | 13.5 | 140 | 8.70% | 9.6% | 145 | 148 |
| 4 | 16.5 | 138 | 10.70% | 12.0% | 105 | 101 |
| 5 | 20.7 | 286 | 6.70% | 7.2% | 271 | 297 |
| 6 | 5.9 | 58 | 9.10% | 10.2% | 62 | 69 |
| 7 | 19.4 | 68 | 22.30% | 28.5% | 50 | 48 |
| 8 | 7 | 222 | 3.10% | 3.2% | 161 | 188 |
| 9 | 16.5 | 133 | 11.00% | 12.4% | 136 | 155 |
| 10 | 5.2 | 133 | 3.80% | 3.9% | 99 | 105 |
| 11 | 18.9 | 65 | 22.50% | 29.1% | 77 | 76 |
| 12 | 12.6 | 61 | 17.20% | 20.7% | 64 | 59 |
| 13 | 16.9 | 62 | 21.50% | 27.3% | 103 | 76 |
| 14 | 18.5 | 47 | 28.20% | 39.4% | 77 | 53 |
| 15 | 12.6 | 44 | 22.30% | 28.6% | 64 | 41 |
| 16 | 30.8 | 138 | 18.30% | 22.3% | 174 | 168 |

Across the experimental results, the particle focusing length L_{f} was greater than the particle migration length L₀. The particle migration length L₀ ranged from 0% of the total liquid channel length L_{D} to 28.2% of the total liquid channel length L_{D}. Furthermore, the particle migration length L₀ ranged from 0% of the particle migration length L_{f} to 39.4% of the particle migration length L_{f}. As such, in some embodiments, liquid channels consistent with the technology disclosed herein will have a liquid channel length L_{D} that is about equal to the particle migration length L_{f}. In various embodiments, liquid channels consistent with the technology disclosed herein will have a liquid channel length L_{D} that is greater than the particle migration length L_{f}. Based on the collected data, it appears that, in many embodiments, the liquid channel length L_{D} is less than 40% greater than the particle migration length L_{f}. The liquid channel length L_{D} may be less than or equal to 30% greater than the particle migration length L_{f}. The liquid channel length L_{D} may be less than or equal to 20% greater than the particle migration length L_{f}. In some embodiments the liquid channel length L_{D} may be from 3% to 20% greater than the particle migration length L_{f}.

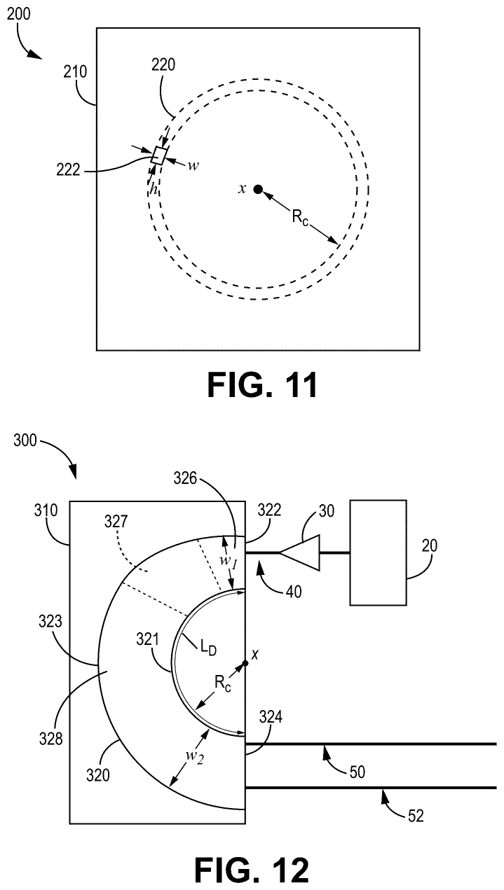

FIGS. 10 and 11 show a schematic view of another example hydrodynamic separator 200 consistent with some embodiments. FIG. 10 is a schematic perspective view and FIG. 11 is a schematic facing view of the inlet side of the hydrodynamic separator, where the liquid channel 220 is represented by dotted lines. The hydrodynamic separator 200 is generally consistent with the descriptions above except where contradictory. The hydrodynamic separator 200 is configured to focus particles that are dispersed in a liquid stream. The hydrodynamic separator 200 is constructed of a substrate 210. The substrate 210 defines a liquid channel 220 having an inlet 222 and an outlet 224. The liquid is configured to flow through the liquid channel 220 of the hydrodynamic separator 200 from the inlet 222 to the outlet 224. While not currently depicted, it is noted that a first outlet branch and a second outlet branch can extend outward from the outlet 224, similar to the discussion above with reference to FIG. 1.

The liquid channel 220 defines a channel length L_{D} from the inlet 222 to the outlet 224. The liquid channel 220 is generally curved to define an inner radius R_{C} about a central axis x. As such, the liquid channel 220 extends circumferentially about the central axis x to define a channel arc measure. In the current example, the liquid channel 220 extends about 810° about the central axis x. In the current example, the inner radius R_{C} is substantially constant along the length of the channel. In the current example, the liquid channel 220 forms a helix about the central axis x. The helical arrangement of the liquid channel 220 accommodates both a constant inner radius R_{C} and multiple revolutions about the central axis x. In some embodiments, however, the inner radius is not constant.

The liquid channel 220 can have a rectangular cross-section along the channel length in some embodiments, which is visible in FIG. 11 at the inlet 222. The cross-section of the liquid channel 220 is generally perpendicular to the direction of fluid flow through the channel 220. The channel 220 has a height (h) that is visible in FIG. 2, and a width (w) that is visible in FIG. 11. The channel 220 also has a hydraulic diameter (D_{H}) as has been disclosed.

Similar to examples discussed above, particle focusing can occur in two distinct stages. To optimize the liquid channel length L_{D}, and a fully focused region is avoided so that the entire length of the liquid channel is the particle migration length L₀ and the particle focusing length L_{f}. Optimization of the liquid channel length L_{D} and/or arc measure is generally consistent with the discussion above.

In various embodiments, such as embodiments consistent with the example of FIGS. 1-2 and 10-11, the liquid channel dimensions such as height h, width w, and inner radius R_{C} are substantially constant along the length of the liquid channel, meaning that such dimensions do not vary beyond 5% of the weighted average value of the dimension along the length of the liquid channel. The equations provided herein are generally for optimization of a liquid channel length where the liquid channel has a substantially constant inner radius R_{C}. In some embodiments, the channel width w is not substantially constant along the length of the channel. In such embodiments, the weighted average of the channel width w along the channel length can be used in the equations provided herein for optimization of the liquid channel length. In various examples, the optimized channel length may be based on the weighted average of the channel dimensions within the focusing region.

In some embodiments of the technology disclosed herein, the hydrodynamic separator system has a liquid channel width that is tapered for at least a portion of the length of the liquid channel. The word “taper” is used herein to mean a relatively gradual expansion/contraction that excludes an abrupt transition, such as a stepped transition, between the first width w₁ and the second width w₂. The taper can be linear, parabolic, or exponential, as examples. Other taper shapes are additionally possible, including combinations of tapered shapes along the length of the tapered region. It has been discovered that liquid channels that are tapered may advantageously decrease the focusing length of the channel, which may advantageously decrease the requisite length of the channel to achieve a desired separation efficiency. From a practical perspective, the smaller the width of a liquid channel, the shorter the pathway for particles to focus towards the inner wall, which allows the system to have a smaller size. On the other hand, the larger the width of a liquid channel, the lower the pressure drop along the channel, which reduces the energy needed to pump liquid through the channel. Furthermore, a relatively large width of a liquid channel at the outlets may advantageously facilitate separation of the portion of the fluid stream that has the focused particles from the rest of the fluid stream. Tapering the liquid channel may advantageously balance these and other factors while achieving the desired separation efficiency.

FIG. 12 is a schematic representation of yet another example hydrodynamic separator system consistent with some embodiments. The system has a fluid source 20, a pump 30, an inlet flow channel 40 and outlet flow branches 50, 52 as discussed above with reference to FIG. 1. The system has a hydrodynamic separator 300 that is generally consistent with the descriptions above except where contradictory. The hydrodynamic separator 300 is configured to focus particles that are dispersed in a liquid stream. The hydrodynamic separator 300 is constructed of a substrate 310. The substrate 310 defines a liquid channel 320 having an inlet 322 and an outlet 324. The liquid is configured to flow through the liquid channel 320 of the hydrodynamic separator 300 from the inlet 322 to the outlet 324.

The liquid channel 320 defines a channel length L_{D} from the inlet 322 to the outlet 324. The liquid channel 320 is generally curved to define an inner radius R_{C} about a central axis x. As such, the liquid channel 320 extends circumferentially about the central axis x to define a channel arc measure. In the current example, the liquid channel 320 extends about 180° about the central axis x. In the current example, the inner radius R_{C} is substantially constant along the length of the channel, but in some other embodiments the inner radius is not constant.

The liquid channel 320 may have a rectangular cross-section along the channel length, which is not currently visible, but the liquid channel 320 can have a cross-section that forms other shapes, which has been described above. The liquid channel 320 has a height (h) that is not currently visible, and a first channel width w₁ and a second channel width w₂ that is visible in FIG. 12. In this particular example, the liquid channel 320 does not have a constant width. The channel width tapers between the inlet and the outlet. Specifically, a first region 326 of the liquid channel 320 defines a first width w₁, a second region 328 of the liquid channel 320 defines a second width w₂, and a tapered region 327 extends between the first width w₁ and the second width w₂ to provide a smooth transition from the first width w₁ to the second width w₂. In the current example, the width of the liquid channel tapers from a smaller width to a larger width. More particularly, the liquid channel width increases along at least a portion of the length of the liquid channel 320.

A relatively larger channel width at the outlet 324 may advantageously improve separation of focused particles from the remaining fluid stream simply based on the physical limitations associated with the relative distance between the focused particles (generally positioned towards the inner wall 321) and the fluid lacking focused particles (towards the outer wall 323). The smaller the channel width, the higher the chance that a portion of the focused particles exit into the second outlet flow branch 52 instead of the first outlet flow branch 50 simply because the first outlet flow branch 50 and the second outlet flow branch 52 are closer together. Additionally, with a relatively wider channel width, the focused particles may advantageously focus in a relatively smaller proportion of the total channel width, further reducing the opportunity for particles to inadvertently exit through the second outlet branch 52.

In some embodiments the first region 326 and the second region 328 can have about equal lengths, but in the current embodiment the first region 326 is shorter than the second region 328. In some embodiments the first region 326 has a larger length than the second region 328. In some embodiments the tapered region 327 is longer than one or both of the first region 326 or second region 328. In the current example, only the radius of the outer wall 323 of the liquid channel 320 tapers between first region 326 and the second region 328. In some other embodiments, the radius of the outer wall 323 and the radius of the inner wall 321 taper between the first region 326 and the second region 328. In yet other embodiments, only the radius of the inner wall 321 tapers between the first region 326 and the second region 328.

While in the current example there is a single tapered region along the length of the liquid channel 320, it will be appreciated that the liquid channel 320 may have a plurality of tapered regions 327 along the channel length.

In some implementations, the optimal channel length can be approximated by using the weighted average of the width along the length of the liquid channel 320 in such calculations. In some implementations consistent with FIG. 12, to achieve maximum focusing, the following is true:

$$1 \leq \frac{{L}_{w 1}}{{L}_{f ( w 1 )}} + \frac{{L}_{w 2}}{{L}_{f ( w 2 )}}$$

where L_{w1} and L_{w2} are the actual lengths of the first region 326 (having the first width w₁) and the second region 328 (having the second width w₂) of the channel, respectively. L_{f(w1)} and L_{f(w2)} are the theoretical linear focusing lengths of a channel consistent with the first region 326 and a channel consistent with the second region 328, respectively. In the case that the length of the tapering region 327 is relatively small relative to L_{w1} and L_{w2} the linear focusing length (L_{f}) would be the following:

L_{f}=αL_{f(w1)}+(1−α)L_{f(w2)}

where

$$α = \frac{{L}_{w 1}}{{L}_{f ( w 1 )}}$$

and corresponds to the percent of focusing that occurs within the first region 326 and where

$$( 1 - α ) = \frac{{L}_{w 2}}{{L}_{f ( w 2 )}}$$

and corresponds to the percent of additional focusing that occurs within the second region 328. By “relatively small” it is meant that the tapering region 327 is less than 30%, 20%, or even less than 10% of the combined length of the first region 326 and the second region 328.

In some other implementations, for purposes of calculating the total length of the focusing region, a first portion of the tapered region may be considered part of the length of the first region 326 and a second portion of the tapered region may be considered part of the length of the second region 328. For example, half of the length of tapered region 327 may be considered part of the length of the first region 326 and the other half of the length of the tapered region 327 may be considered part of the length of the second region 328. Other approaches may also be used.

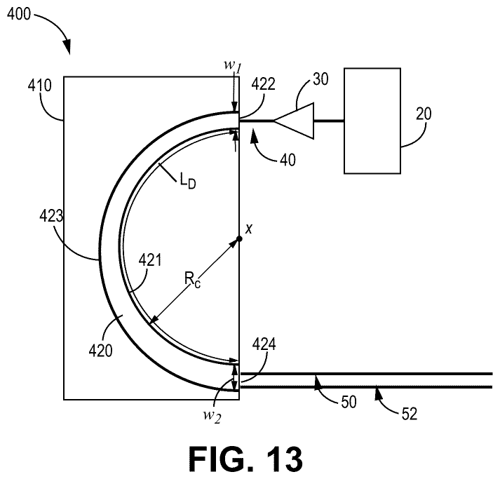

FIG. 13 is a schematic representation of yet another example hydrodynamic separator system consistent with some embodiments. The system has a fluid source 20, a pump 30, an inlet flow channel 40 and outlet flow branches 50, 52 as discussed above with reference to FIG. 1. The system has a hydrodynamic separator 400 that is generally consistent with the descriptions above except where contradictory to the current discussion. The hydrodynamic separator 400 is configured to focus particles that are dispersed in a liquid stream. The hydrodynamic separator 400 is constructed of a substrate 410. The substrate 410 defines a liquid channel 420 having an inlet 422 and an outlet 424. The liquid is configured to flow through the liquid channel 420 of the hydrodynamic separator 400 from the inlet 422 to the outlet 424.

The liquid channel 420 defines a channel length L_{D} from the inlet 422 to the outlet 424. The liquid channel 420 is generally curved to define an inner radius R_{C} about a central axis x. The liquid channel 420 extends circumferentially about the central axis x to define a channel arc measure. In the current example, the liquid channel 420 extends about 180° about the central axis x. In the current example, the inner radius R_{C} is substantially constant along the length of the channel, but in some other embodiments the inner radius is not constant.

The liquid channel 420 may have a rectangular or an alternatively shaped cross-section along the channel length, which is not currently visible, but can be similar to that depicted in FIG. 2 or descriptions of other shapes elsewhere herein. The liquid channel 420 has a height (h) (see FIG. 2), and a first channel width w₁ and a second channel width w₂. In this particular example, the liquid channel 420 does not have a constant width. The channel width tapers between the inlet 422 and the outlet 424. Unlike the example described above, in the current example the channel width tapers from the inlet 422 to the outlet 424. In some other examples, however, a portion of the length of the channel 420 can have a constant width and another portion of the length of the channel 420 can have a tapered width.

In the current example, only the radius of the outer wall 423 of the liquid channel 420 tapers between the inlet 422 and the outlet 424. In some other embodiments, the radius of the outer wall 423 and the radius of the inner wall 421 each taper between the inlet 422 and the outlet 424. In yet other embodiments, only the radius of the inner wall 421 tapers between the inlet 422 and the outlet 424.

In the current example, the width of the liquid channel tapers from a smaller width to a larger width. More particularly, the liquid channel width increases along at least a portion of the length of the liquid channel 420.

It is noted that a channel that tapers from a larger width to a smaller width from the inlet to the outlet may be undesirable in some implementations. For example, a relatively small channel outlet 424 may pose practical challenges in separating the portion of the fluid having the focused particles from the rest of the fluid via the first outlet branch 50 and the second outlet branch 52.

### EXAMPLES

### Example A (25 μm Particles in Water)

A hydrodynamic separator is designed to focus 25 μm particles in water. Key parameters are in Table 2. The flowrate range at which particles focus is approximately 1.3 mL/min to 6.5 mL/min (Dean number=5.1 to 25.3). The linear focusing region length is calculated for these flowrates as shown in Table 3. The system pressure drop is an estimated pressure drop based on straight channel calculations and does not include minor losses or effects of secondary flows.

TABLE 2

| | |
|---|---|
| Fluid Density (g/mL) | 0.998 |
| Channel Height (μm) | 150 |
| Channel Width (μm) | 500 |
| Hydraulic Dimension (μm) | 231 |
| Viscosity (cP) | 1 |
| Radius of Curvature (mm) | 20 |
| Particle Confinement | 0.11 |

TABLE 3

| | | $156.2 \frac{{R}_{c}}{Re} {( \frac{w}{{D}_{H}} )}^{2} + 24.3$ | | $1598.8 \frac{{R}_{c} {aw}^{2}}{Re {D}_{H}^{3}} + 6.4$ | |
|---|---|---|---|---|---|
| | | | System | | System |
| | Dean | | Pressure | | Pressure |
| Flow Rate | Number | L_{f} | Drop | L_{f} | Drop |
| (mL/min) | (De) | (mm) | (mbar) | (mm) | (mbar) |
| 1.31 | 5.1 | 245 | 415 | 250 | 423 |
| 2.60 | 10.1 | 135 | 456 | 128 | 434 |
| 3.91 | 15.2 | 98 | 498 | 87 | 442 |
| 5.20 | 20.2 | 79 | 535 | 67 | 448 |
| 6.51 | 25.3 | 68 | 575 | 55 | 465 |

### Example B (10 μm Particles in Fuel, Varying Radius of Curvature)

A hydrodynamic separator is designed to focus 10 μm particles in a fluid. Key parameters are in Table 4. The linear focusing region length and estimated pressure drop can be calculated for different hydrodynamic separator radii at a constant Dean number (De=10). This data is shown in Table 5. The system pressure drop is an estimated pressure drop based on straight channel calculations and does not include minor losses or effects of secondary flows. At larger radii of curvatures the flowrate through the channel increases, but at the drawback of increased pressure drop.

TABLE 4

| | |
|---|---|
| Fluid Density (g/mL) | 0.85 |
| Channel Height (μm) | 100 |
| Channel Width (μm) | 150 |
| Hydraulic Dimension (μm) | 120 |
| Viscosity (cP) | 3 |
| Particle Confinement | 0.08 |

TABLE 5

| | | | $156.2 \frac{{R}_{c}}{Re} {( \frac{w}{{D}_{H}} )}^{2} + 24.3$ | | $1598.8 \frac{{R}_{c} {aw}^{2}}{Re {D}_{H}^{3}} + 6.4$ | |
|---|---|---|---|---|---|---|
| | | | | System | | System |
| Radius of | | | | Pressure | | Pressure |
| Curvature | Flow Rate | Dean | L_{f} | Drop | L_{f} | Drop |
| (mm) | (mL/min) | Number | (mm) | (mbar) | (mm) | (mbar) |
| 10 | 3.4 | 10 | 43.3 | 10633 | 21.6 | 5304 |
| 20 | 4.8 | 10 | 51.2 | 17749 | 28.4 | 9828 |
| 30 | 5.9 | 10 | 57.1 | 24331 | 33.4 | 14228 |
| 40 | 6.8 | 10 | 62.3 | 30596 | 37.8 | 18570 |

### Example C (8-12 μm Particles in Wine)

A hydrodynamic separator is designed to focus 8-12 μm particles in wine. This represents the process of removing yeast from beer or wine during clarification. Key parameters are in Table 6. The linear focusing region length is calculated for different flowrates as shown in Table 7. The largest particle size (12 μm) is used for this calculation. The system pressure drop is an estimated pressure drop based on straight channel calculations and does not include minor losses or effects of secondary flows.

TABLE 6

| | |
|---|---|
| Fluid Density (g/mL) | 1.05 |
| Channel Height (μm) | 75 |
| Channel Width (μm) | 150 |
| Hydraulic Dimension (μm) | 100 |
| Fluid Viscosity (cP) | 1.8 |
| Radius of Curvature (mm) | 20 |
| Particle Confinement (8 μm) | 0.08 |
| Particle Confinement (12 μm) | 0.12 |

TABLE 7

| | | $156.2 \frac{{R}_{c}}{Re} {( \frac{w}{{D}_{H}} )}^{2} + 24.3$ | | $1598.8 \frac{{R}_{c} {aw}^{2}}{Re {D}_{H}^{3}} + 6.4$ | |
|---|---|---|---|---|---|
| | | | System | | System |
| | Dean | | Pressure | | Pressure |
| Flow Rate | Number | L_{f} | Drop | L_{f} | Drop |
| (mL/min) | (De) | (mm) | (mbar) | (mm) | (mbar) |
| 1.16 | 5 | 94 | 9070 | 63 | 6040 |
| 2.32 | 10 | 59 | 11390 | 49 | 9300 |
| 3.48 | 15 | 48 | 13900 | 34 | 9940 |
| 4.64 | 20 | 42 | 16210 | 27 | 10440 |

### Example D (Device with Two Widths)

A hydrodynamic separator is configured to focus 8-12 μm particles in wine. In some implementations, such a separator can be used to remove yeast from beer or wine during clarification. The hydrodynamic separator has two regions of different widths, w₁ and w₂ and a relatively small transition region having a length of 1 mm or less. The flow rate is 3.48 mL/min. Key parameters are in Table 8. The separator is configured to accomplish α% of the focusing in the first region, and (1−α)% of the focusing in the second region, such that particles are fully focused at the end of the second region. The length of each region, L_{w1} and L_{w2}, and the total focusing length, L_{f} are calculated in Table 9.

TABLE 8

| | |
|---|---|
| Fluid Density (g/mL) | 1.05 |
| Fluid Flowrate (mL/min) | 3.48 |
| Channel Height (μm) | 75 |
| Channel Width Region 1 (μm) | 100 |
| Channel Width Region 2 (μm) | 150 |
| Hydraulic Dimension Region 1 | 86 |
| (μm) | |
| Hydraulic Dimension Region 2 | 100 |
| (μm) | |
| Fluid Viscosity (cP) | 1.8 |
| Radius of Curvature (mm) | 20 |
| Particle Confinement Region 1 | 0.09 |
| (8 μm) | |
| Particle Confinement Region 1 | 0.14 |
| (12 μm) | |
| Particle Confinement Region 2 | 0.08 |
| (8 μm) | |
| Particle Confinement Region 2 | 0.12 |
| (12 μm) | |

TABLE 9

| Region 1 | Region 2 | $156.2 \frac{{R}_{c}}{Re} {( \frac{w}{{D}_{H}} )}^{2} + 24.3$ | | | $1598.8 \frac{{R}_{c} {aw}^{2}}{Re {D}_{H}^{3}} + 6.4$ | | |
|---|---|---|---|---|---|---|---|
| focusing | focusing | L_{w1} | L_{w2} | L_{f} | L_{w1} | L_{w2} | L_{f} |
| (α) | (1 − α) | (mm) | (mm) | (mm) | (mm) | (mm) | (mm) |
| 0% | 100% | 0 | 48 | 48 | 0 | 34 | 34 |
| 25% | 75% | 9 | 36 | 45 | 5 | 26 | 31 |
| 50% | 50% | 18 | 24 | 42 | 11 | 17 | 28 |
| 75% | 25% | 26 | 12 | 38 | 16 | 9 | 25 |
| 100% | 0% | 35 | 0 | 35 | 21 | 0 | 21 |

While it can generally be observed that by increasing the percentage of focusing in the narrower channel (region 1) that the overall focusing length can be decreased, this will come at the expense of increased pressure drop due to the smaller channel dimensions. An optimal design will depend on application requirements.

### Example E (Channel with Tapering Width)

Two microfluidic channels are compared to identify the impact of tapering the channel width of a microfluidic channel on the focusing length using the theoretical calculations identified herein. The baseline microfluidic channel has a constant width of 628.4 μm from the channel inlet to the channel outlet, and the comparison microfluidic channel has a channel width at the inlet of 500 μm and a channel width at the outlet of 628.4 μm. The channel width of the comparison microfluidic channel has a taper from the channel inlet to the channel outlet at a constant rate k of 0.001 mm in channel width per mm in channel length (mm/mm). In the tapered design, the inner wall maintains a constant radius of curvature while the outer wall tapers outward.

The baseline microfluidic channel and the comparison microfluidic channel each had a constant channel height of 150 μm and an inner wall having a constant inner radius of curvature of 25 mm. Further, the flow rate of the liquid through each of the channels is equal.

The lateral migration of particles due to particle focusing was assumed to be proportional to the radial component of the Dean Flow at the position along the length of the liquid channel, x:

$${U}_{D} ( x ) = \frac{w ( x ) U ( x )}{{L}_{f} ( x )}$$

where w(x) is the channel width at position x along the length of liquid channel, U(x) is the average velocity of the fluid through the channel at position x, and L_{f}(x) is the required length of the linear focusing region based on device and fluid properties at position x, assuming a constant channel width w(x). Experimental results of particle movement in straight channels found the linear focusing region length to be:

$${L}_{f} ( x ) = 156.2 \frac{{R}_{c}}{Re ( x )} {( \frac{w ( x )}{{D}_{H} ( x )} )}^{2} + 24.3$$

where Re(x) is the Reynolds number at position x and D_{H}(x) is the Hydraulic Diameter at position x, assuming a constant width w at position x.

In tapered channels where the inner wall has a constant radius and the outer wall tapers outward, the fluid flowing through the channel expands outward to fill the channel. As a result, any particles within the channel migrate outward (i.e., away from the inner wall and towards the outer wall), which can be approximated by the following equation:

$${U}_{M} ( x ) = \frac{p ( x ) U ( x ) k}{w ( x )}$$

where U_{M}(x) is the outward particle migration, p(x) is the distance from the particle to the inner channel wall, U(x) is the average velocity of the fluid, k is the rate of outward tapering per unit length, and w(x) is the channel width at location x. The outward lateral migration of the particles due to channel expansion counteracts the particle focusing. Thus, the lateral migration of particles U_{DM}(x) in an outwardly tapered channel is approximated by the following equation:

$${U}_{D M} ( x ) = {U}_{D} ( x ) - {U}_{M} ( x )$$

$$or$$

$${U}_{D M} ( x ) = \frac{w ( x ) U ( x )}{{L}_{f} ( x )} - \frac{p ( x ) U ( x ) k}{w ( x )} .$$

Numeric integrations were developed that were able to approximate the time required for the particles to migrate laterally from the outer wall to the inner wall of the channel (focusing time):

$${t}_{f , tapered} = {\int }_{0}^{{w}_{0}} \frac{d w}{{U}_{D} ( x )} ,$$

where w₀ is the initial width of the channel. The focusing length L_{f,tapered} of the tapered channel, which is the channel length required for particles to migrate laterally from the outer wall to the inner wall of the channel is the following:

$${L}_{f , tapered} = {\int }_{0}^{{t}_{f , tapered}} U ( x ) dt .$$

The following table reports the two example designs described above that illustrate the reduction in required focusing length resulting from addition of a taper. Note the final widths and linear fluid velocities are identical in the two designs—thus the flow rates are equal, making the designs comparable.

TABLE 10

| | Inner | | Initial | Final | Initial | Final | |
|---|---|---|---|---|---|---|---|
| | radius R_{C} | Height | width | width | velocity | velocity | L_{f} |
| Device | (mm) | (μm) | (μm) | (μm) | (m/s) | (m/s) | (mm) |
| Baseline (no taper) | 25 | 150 | 628.4 | 628.4 | 0.796 | 0.796 | 160.8 |
| Comparison (taper) | 25 | 150 | 500 | 628.4 | 1 | 0.796 | 128.5 |

Notably, if the outward particle migration U_{M}(x) due to channel expansion is greater than the inward particle migration due to particle focusing U_{D}(x), then the particles within the fluid may never focus, as some particles would ultimately be pulled outward rather than inward. As such, it may be desirable to limit the rate of expansion of the width of the channel k, which in turn limits the outward particle migration U_{M}(x) relative to the inward particle migration due to particle focusing U_{D}(x).

Table 11 below demonstrates the impact of the rate of tapering k on the focusing length L_{f}. In this example the fluid is water. The channel height is constant between the inlet and the outlet and 150 μm, and the initial channel width w₀ is 500 μm. The channel has an inner wall having a constant inner radius of curvature of 25 mm. The initial fluid velocity of the water through the channel is 1 m/s.

TABLE 11

| k (mm/mm) | L_{f} (mm) |
|---|---|
| 0.000 | 103.8 |
| 0.001 | 128.5 |
| 0.002 | 175.6 |
| 0.003 | 316.4 |
| 0.004 | infinity |

Note that as k increases, the focusing length L_{f} significantly increases. Various sets of data have been examined in accordance with the operating conditions of microfluidic channels to approximate the focusing length L_{f} at different rates of tapering, and it appears that k is generally less than 0.01 mm/mm. In some embodiments k is less than 0.007 mm/mm. In some embodiments k is less than or equal to 0.005 mm/mm or even less than or equal to 0.004 mm/mm. If a taper is incorporated in a microfluidic channel, the taper will generally be greater than 0 mm/mm.

The above reported data for tapered channels are relevant to channels having a taper from the channel inlet to the channel outlet. In some implementations, the rate of tapering k can be greater than 0.004 mm/mm, 0.005 mm/mm, 0.007 mm/mm, 0.01 mm/mm, or even 0.016 mm/mm, such as where the channel tapers from a midpoint along the channel (between the channel inlet and the channel outlet) towards the outlet. In implementations where the taper starts towards the end of the channel, it is predicted that the tapering rate can be relatively increased because many particles may already be focused towards the inner wall and thus may not migrate outward significantly by the fluid filling the expanding channel.

### Example F

Table 12 below shows results comparing a channel having constant dimensions (150 μm height, 500 μm width, 25 mm radius of curvature) to a tapered channel having the same height and radius of curvature that doubles in width from 500 μm to 1000 μm (1 mm) in the final quarter of the length of the channel. The channels have a total fluid volume flow split that is fairly consistent (13/87 vs 15/85), but a considerable increase (59% to 79%) in particle retention in the inner channel as a result of the taper was observed.

TABLE 12

| | % flow inner | % particles |
|---|---|---|
| | channel | inner channel |
| Constant width | 13% | 59% |
| Tapered width | 15% | 79% |

### EXEMPLARY ASPECTS

Aspect 1. A hydrodynamic separator configured to separate a liquid having dispersed particles having a diameter (a), comprising:
a substrate; and
a liquid channel defined by the substrate, the liquid channel configured to receive a liquid within the channel, the liquid channel having an inlet and an outlet, wherein:
the liquid channel has an inner wall defining an inner radius around a central axis and an outer wall defining an outer radius around the central axis,
the liquid channel has a liquid channel length along the inner wall from the inlet to the outlet,
the liquid channel has a rectangular cross-section along the liquid channel length, and the rectangular cross-section has a channel width between the inner wall and outer wall, where the channel has a tapered region where the channel width increases at a constant rate between 0.00 and 0.01 mm per mm liquid channel length towards the outlet.

Aspect 2. The hydrodynamic separator of any one of Aspects 1 and 3-11, wherein the tapered region extends from the inlet to the outlet.

Aspect 3. The hydrodynamic separator of any one of Aspects 1-2 and 4-11, wherein the inner radius is constant from the inlet to the outlet.

Aspect 4. The hydrodynamic separator of any one of Aspects 1-3 and 5-11, wherein the outer radius tapers outward between the inlet and the outlet.

Aspect 5. The hydrodynamic separator of any one of Aspects 1-4 and 6-11, wherein the liquid channel has a first region having a first channel width and a first liquid channel length, a second region having a second channel width and a second liquid channel length, and the tapered region having a tapered region length that extends from the first region to the second region.

Aspect 6. The hydrodynamic separator of any one of Aspects 1-5 and 7-11, wherein the first region has a larger length than the second region.

Aspect 7. The hydrodynamic separator of any one of Aspects 1-6 and 8-11, wherein the separator is configured to have a Dean number (De) between 5 and 25 in the first region and the second region.

Aspect 8. The hydrodynamic separator of any one of Aspects 1-7 and 9-11, wherein the particle diameter (a) is greater than 8% of a hydraulic diameter (D_{H}) in at least the first region.

Aspect 9. The hydrodynamic separator of any one of Aspects 1-8 and 10-11, wherein the separator is configured to separate particles up to three times as dense as the liquid.

Aspect 10. The hydrodynamic separator of any one of Aspects 1-9 and 11, wherein the outlet comprises a first outlet and a second outlet.

Aspect 11. The hydrodynamic separator of any one of Aspects 1-10, wherein the liquid channel is one of a plurality of identical liquid channels.

Aspect 12. A hydrodynamic separator configured to separate a liquid having dispersed particles having a diameter (a), comprising:
a substrate; and
a liquid channel at least partially defined by the substrate, the liquid channel configured to receive a liquid within the channel, the liquid channel having an inlet and an outlet comprising a first outlet branch and a second outlet branch, wherein:
the liquid channel has an inner wall defining an inner radius around a central axis and an outer wall defining an outer radius around the central axis,
the liquid channel has a liquid channel length along the inner wall from the inlet to the outlet, and
the liquid channel has a channel width between the inner wall and outer wall, where the channel has a tapered region where the channel width increases towards the outlet.

Aspect 13. The hydrodynamic separator of any one of Aspects 12 and 14-31, wherein the tapered region extends from the inlet to the outlet.

Aspect 14. The hydrodynamic separator of any one of Aspects 12-13 and 15-31, wherein the inner radius is constant from the inlet to the outlet.

Aspect 15. The hydrodynamic separator of any one of Aspects 12-14 and 16-31, wherein the outer radius tapers outward between the inlet and the outlet.

Aspect 16. The hydrodynamic separator of any one of Aspects 12-15 and 17-31, wherein the liquid channel has a first region having a first channel width and a first liquid channel length, a second region having a second channel width and a second liquid channel length, and the tapered region having a tapered region length that extends from the first region to the second region.

Aspect 17. The hydrodynamic separator of any one of Aspects 12-16 and 18-31, wherein the first region has a larger length than the second region.

Aspect 18. The hydrodynamic separator of any one of Aspects 12-17 and 19-31, wherein the separator is configured to have a Dean number (De) between 5 and 25 in the first region and the second region.

Aspect 19. The hydrodynamic separator of any one of Aspects 12-18 and 20-31, wherein the particle diameter (a) is greater than 8% of a hydraulic diameter (D_{H}) in at least the first region.

Aspect 20. The hydrodynamic separator of any one of Aspects 12-19 and 21-31, wherein the separator is configured to separate particles up to three times as dense as the liquid.

Aspect 21. The hydrodynamic separator of any one of Aspects 12-20 and 22-31, wherein the inner radius is greater than or equal to 10 mm and less than or equal to 100 mm.

Aspect 22. The hydrodynamic separator of any one of Aspects 12-21 and 23-31, wherein the liquid channel is one of a plurality of identical liquid channels defined by the substrate.

Aspect 23. The hydrodynamic separator of any one of Aspects 12-22 and 24-31, wherein the liquid channel has a width ranging from 400 μm to 1000 μm.

Aspect 24. The hydrodynamic separator of any one of Aspects 12-23 and 25-31, wherein the liquid channel has a height ranging from 100 μm to 500 μm.

Aspect 25. The hydrodynamic separator of any one of Aspects 12-24 and 26-31, wherein the liquid channel has a polygonal cross-section along the liquid channel length.

Aspect 26. The hydrodynamic separator of any one of Aspects 12-25 and 27-31, wherein the liquid channel has a rectangular cross-section along the liquid channel length.

Aspect 27. The hydrodynamic separator of any one of Aspects 12-26 and 28-31, wherein the channel width of the liquid channel does not change more than 10 mm per mm liquid channel length along the liquid channel.

Aspect 28. The hydrodynamic separator of any one of Aspects 12-27 and 29-31, wherein the channel width increases at a constant rate in the tapered region.

Aspect 29. The hydrodynamic separator of any one of Aspects 12-28 and 30-31, wherein the liquid channel has a first region having a first channel width and a tapered region having an increasing channel width from the first region to the outlet.

Aspect 30. The hydrodynamic separator of any one of Aspects 12-29 and 31, wherein the liquid channel has a plurality of tapered regions, each having an increasing channel width towards the outlet.

Aspect 31. The hydrodynamic separator of any one of Aspects 12-30, wherein the liquid channel is a microfluidic channel.

It should also be noted that, as used in this specification and the appended claims, the phrase “configured” describes a system, apparatus, or other structure that is constructed to perform a particular task or adopt a particular configuration. The word “configured” can be used interchangeably with similar words such as “arranged”, “constructed”, “manufactured”, and the like.

All publications and patent applications in this specification are indicative of the level of ordinary skill in the art to which this technology pertains. All publications and patent applications are herein incorporated by reference to the same extent as if each individual publication or patent application was specifically and individually indicated by reference. In the event that any inconsistency exists between the disclosure of the present application and the disclosure(s) of any document incorporated herein by reference, the disclosure of the present application shall govern.

This application is intended to cover adaptations or variations of the present subject matter. It is to be understood that the above description is intended to be illustrative, and not restrictive, and the claims are not limited to the illustrative embodiments as set forth herein.

What is claimed is:

1. A hydrodynamic separator configured to separate a liquid having dispersed particles having a diameter (a), comprising:
a substrate; and
a liquid channel at least partially defined by the substrate, the liquid channel configured to receive a liquid within the channel, the liquid channel having an inlet and an outlet comprising a first outlet branch and a second outlet branch, wherein:
the liquid channel has an inner wall defining an inner radius around a central axis and an outer wall defining an outer radius around the central axis,
the liquid channel has a liquid channel length along the inner wall from the inlet to the outlet,
the liquid channel has a channel width between the inner wall and outer wall, where the channel has a tapered region where the channel width increases towards the outlet.

2. The hydrodynamic separator of claim 1, wherein the tapered region extends from the inlet to the outlet.

3. The hydrodynamic separator of claim 1, wherein the inner radius is constant from the inlet to the outlet.

4. The hydrodynamic separator of claim 1, wherein the outer radius tapers outward between the inlet and the outlet.

5. The hydrodynamic separator of claim 1, wherein the liquid channel has a first region having a first channel width and a first liquid channel length, a second region having a second channel width and a second liquid channel length, and the tapered region having a tapered region length that extends from the first region to the second region.

6. The hydrodynamic separator of claim 5, wherein the first region has a larger length than the second region.

7. The hydrodynamic separator of claim 5, wherein the separator is configured to have a Dean number (De) between 5 and 25 in the first region and the second region.

8. The hydrodynamic separator of claim 5, wherein the particle diameter (a) is greater than 8% of a hydraulic diameter (D_{H}) in at least the first region.

9. The hydrodynamic separator of claim 1, wherein the separator is configured to separate particles up to three times as dense as the liquid.

10. The hydrodynamic separator of claim 1, wherein the inner radius is greater than or equal to 10 mm and less than or equal to 100 mm.

11. The hydrodynamic separator of claim 1, wherein the liquid channel is one of a plurality of identical liquid channels defined by the substrate.

12. The hydrodynamic separator of claim 1, wherein the liquid channel has a width ranging from 400 μm to 1000 μm.

13. The hydrodynamic separator of claim 1, wherein the liquid channel has a height ranging from 100 μm to 500 μm.

14. The hydrodynamic separator of claim 1, wherein the liquid channel has a polygonal cross-section along the liquid channel length.

15. The hydrodynamic separator of claim 1, wherein the liquid channel has a rectangular cross-section along the liquid channel length.

16. The hydrodynamic separator of claim 1, wherein the channel width of the liquid channel does not change more than 10 mm per mm liquid channel length along the liquid channel.

17. The hydrodynamic separator of claim 1, wherein the channel width increases at a constant rate in the tapered region.

18. The hydrodynamic separator of claim 1, wherein the liquid channel has a first region having a first channel width and a tapered region having an increasing channel width from the first region to the outlet.

19. The hydrodynamic separator of claim 1, wherein the liquid channel has a plurality of tapered regions, each having an increasing channel width towards the outlet.

20. The hydrodynamic separator of claim 1, wherein the liquid channel is a microfluidic channel.
